(19) United States
(12) Patent Application Publication
(10) Pub. No.: US 2026/0169219 A1
(43) Pub. Date: Jun. 18, 2026

(54) COUPLER BETWEEN OPTICAL FIBER AND OPTICAL WAVEGUIDE, AND PHOTONIC INTEGRATED CIRCUIT COMPRISING SAME

(71) Applicant: POSTECH RESEARCH AND BUSINESS DEVELOPMENT FOUNDATION, Pohang-si (KR)

(72) Inventors: Heedeuk SHIN, Pohang-si (KR); Jin Wook KIM, Pohang-si (KR); Yeolheon SEONG, Daejeon (KR)

(73) Assignee: POSTECH RESEARCH AND BUSINESS DEVELOPMENT FOUNDATION, Pohang-si (KR)

(21) Appl. No.: 19/128,543

(22) PCT Filed: Mar. 8, 2023
(86) PCT No.: PCT/KR2023/003189

§ 371 Date: May 8, 2025

(30) Foreign Application Priority Data
Nov. 14, 2022 (KR) 10-2022-0151798

(51) Int. Cl. G02B 6/122; G02B 6/28; G02B 6/30; G02B 6/38

(52) U.S. Cl. CPC G02B 6/1228; G02B 6/2813; G02B 6/30; G02B 6/305; G02B 6/3885

(57) ABSTRACT

An optical fiber and optical waveguide coupler according to an embodiment of the present disclosure includes: an optical fiber coupling part disposed at one end of an optical fiber and having an inclined slanted cross-section; an optical waveguide coupling part corresponding to one part of the optical waveguide and in contact with the optical fiber coupling part; and a refractive index matching part covering the optical fiber coupling part and the optical waveguide coupling part and matching a refractive index between the optical fiber coupling part and the optical waveguide, wherein the optical fiber coupling part exposes a core of the optical fiber, and a width of the one part of the optical waveguide coupling part gradually changes along an extension direction of the optical waveguide.

### CROSS-REFERENCE TO RELATED APPLICATIONS

This is a U.S. national stage of PCT International Application No. PCT/KR2023/003189, filed on Mar. 8, 2023, the entire contents of which are incorporated herein by reference for all purposes. PCT International Application No. PCT/KR2023/003189 claims the benefit of and priority to Korean Patent Application No. 10-2022-0151798, filed on Nov. 14, 2022.

### TECHNICAL FIELD

The present disclosure relates to an optical fiber and optical waveguide coupler and a photonic integrated circuit including the same, and more particularly, to an optical fiber and optical waveguide coupler that may improve an optical coupling efficiency between an optical fiber and an optical waveguide and a photonic integrated circuit including the same.

### BACKGROUND ART

In general, a photonic integrated circuit refers to a circuit that performs computational processing by using an optical signal instead of an electronic signal, and refers to a photonic circuit that performs computational processing by connecting and integrating various optical elements using a path through which light passes, that is, an optical waveguide. This photonic integrated circuit may implement various optical elements, high-density circuit elements, and high mass production. The photonic integrated circuit may be utilized in various fields such as quantum optics, optical communications, and quantum computers by utilizing these characteristics, and the photonic integrated circuit may thus belong to a field that receives increasing attention worldwide.

However, for research or practical use of the photonic integrated circuit, the photonic integrated circuit needs to be connected to an existing optical fiber system. Low optical coupling efficiency (CE), caused by a difference in an optical mode size and a difference in an effective refractive index between the optical fiber of the existing optical fiber system and the optical waveguide of the photonic integrated circuit, may be the most problematic when the optical fiber is connected to the optical waveguide. An edge coupler (EC) and a grating coupler (GC) may generally be used to improve this low optical coupling efficiency.

The edge coupler refers to a coupler that disposes a spot size converter (SSC) at an edge of a substrate on which the photonic integrated circuit is disposed, and connects the optical fiber having a clean cross-section on a straight line of the spot size converter. Therefore, light emitted from the cross-section of the optical fiber may be coupled to the optical waveguide of the photonic integrated circuit through the spot size converter of the edge coupler and converted into a mode usable by the photonic integrated circuit. The edge coupler has high optical coupling efficiency and a wide wavelength bandwidth. However, the edge coupler has a very small tolerance for a position of the optical fiber, and enables optical coupling only from edge to edge of the substrate, which may constrain design of the photonic integrated circuit.

The grating coupler refers to a coupler that couples light emitted from the optical fiber into an optical waveguide mode by forming an index grating that may change a momentum of light on the optical waveguide and disposing the optical fiber at specific angle and position. This grating coupler has appropriate optical coupling efficiency, a large tolerance for the position and angle of the optical fiber, and enables vertical coupling to thus allow light coupling at any position of the substrate on which the photonic integrated circuit is formed, thereby expanding a design constraint of the photonic integrated circuit. However, the grating coupler has a narrow wavelength bandwidth and is significantly affected by the refractive index and structure of the substrate itself, thus making it challenging to implement a universally applicable photonic integrated circuit regardless of a substrate type.

### DISCLOSURE

### Technical Problem

The present disclosure attempts to provide an optical fiber and optical waveguide coupler that achieves high optical coupling efficiency, supports a broad wavelength bandwidth, offers a large tolerance for the position and angle of an optical fiber, enables high design flexibility, and facilitates easy coupling between an optical fiber array and a photonic integrated circuit, and the photonic integrated circuit including the same.

### Technical Solution

According to an embodiment, provided is an optical fiber and optical waveguide coupler including: an optical fiber coupling part disposed at one end of an optical fiber and having an inclined slanted cross-section; an optical waveguide coupling part corresponding to one part of the optical waveguide and in contact with the optical fiber coupling part; and a refractive index matching part covering the optical fiber coupling part and the optical waveguide coupling part and matching a refractive index between the optical fiber coupling part and the optical waveguide, wherein the optical fiber coupling part exposes a core of the optical fiber, and a width of the one part of the optical waveguide coupling part gradually changes along an extension direction of the optical waveguide.

An inclination angle of the slanted cross-section with respect to a central axis of the optical fiber may be greater than 0 degrees and less than 20 degrees.

The slanted cross-section may be flat, and an entire area of the slanted cross-section may be in contact with the optical waveguide coupling part.

The slanted cross-section may have a predetermined radius of curvature, may be convex, and only one part of the slanted cross-section may be in contact with the optical waveguide coupling part.

The slanted cross-section may include a plurality of sub-slanted cross-sections having different inclination angles, and the plurality of sub-slanted cross-sections may include a contact slanted cross-section in contact with the optical waveguide coupling part and a non-contact slanted cross-section not in contact with the optical waveguide coupling part.

A surface roughness of the slanted cross-section may be equal to or less than 100 nm.

The optical waveguide coupling part may include a refractive layer disposed on a substrate and a waveguide pattern disposed on the refractive layer, and a refractive index of the waveguide pattern may be greater than a refractive index of the refractive layer.

A width of the waveguide pattern gradually may decrease along a direction toward an optical contact part between the optical waveguide coupling part and the optical fiber coupling part.

When a width of one end of the waveguide pattern is 150 nm, a taper angle of the waveguide pattern in its extension direction may be 300 to 450 urad.

The refractive index matching part may surround the optical contact part.

A refractive index of the refractive index matching part may be equal to or greater than 1 and may be lower than a refractive index of the optical fiber coupling part.

According to another embodiment, provided is a photonic integrated circuit including: a substrate; an optical waveguide disposed on the substrate; an optical fiber connected to the optical waveguide; and an optical fiber and optical waveguide coupler coupling the optical fiber to the optical waveguide, wherein the optical fiber and optical waveguide coupler includes an optical fiber coupling part disposed at an end of the optical fiber and having an inclined slanted cross-section, an optical waveguide coupling part corresponding to one part of the optical waveguide and in contact with the optical fiber coupling part, and a refractive index matching part covering the optical fiber coupling part and the optical waveguide coupling part and matching a refractive index between the optical fiber coupling part and the optical waveguide, the optical fiber coupling part exposes a core of the optical fiber, and a width of the one part of the optical waveguide coupling part gradually decreases along an extension direction of the optical waveguide.

According to yet another embodiment, provided is a photonic integrated circuit including: a substrate; a plurality of optical waveguides disposed on the substrate; an optical fiber array including a plurality of optical fibers connected to the plurality of optical waveguides, respectively; a plurality of optical fiber and optical waveguide couplers coupling the optical fiber array to the plurality of optical waveguides; and an optical fiber fixing part fixing the optical fiber array onto the plurality of optical waveguides, wherein the optical fiber and optical waveguide coupler includes an optical fiber coupling part disposed at an end of the optical fiber and having an inclined slanted cross-section, an optical waveguide coupling part corresponding to one part of the optical waveguide and in contact with the optical fiber coupling part, and a refractive index matching part covering the optical fiber coupling part and the optical waveguide coupling part and matching a refractive index between the optical fiber coupling part and the optical waveguide, the optical fiber coupling part exposes a core of the optical fiber, a width of the one part of the optical waveguide coupling part gradually decreases along an extension direction of the optical waveguide, and the optical fiber fixing part is disposed on the refractive index matching part and covers and fixes parts of the optical fiber array and the plurality of optical waveguides together.

### Advantageous Effects

In the optical fiber and optical waveguide coupler according to an embodiment of the present disclosure, the slanted cross-section of the optical fiber coupling part may be in contact with the waveguide pattern of the optical waveguide coupling part, and the refractive index of the waveguide pattern may be higher than the refractive index of the refractive layer. Accordingly, in the optical contact part between the optical fiber coupling part and the optical waveguide coupling part, the effective refractive index of the optical waveguide coupling part in the optical mode may be similar to the effective refractive index of the optical fiber coupling part. Therefore, the optical coupling efficiency may be improved.

In addition, the optical fiber and optical waveguide coupler according to an embodiment of the present disclosure may have the high optical coupling efficiency due to the low optical loss throughout the optical communication wavelength band, and thus have the broad applicable wavelength bandwidth.

In addition, the optical fiber and optical waveguide coupler according to an embodiment of the present disclosure may have the large tolerance for the position and angle of the optical fiber and the optical fiber that may be coupled at any position of the substrate on which the photonic integrated circuit is formed, thus achieving high design flexibility.

In addition, the optical fiber and optical waveguide coupler according to an embodiment of the present disclosure is not affected by the refractive index of the substrate itself, may thus be applicable not only to the photonic integrated circuit including the silicon (Si) substrate but also to the photonic integrated circuit including the substrate made of various materials, and is therefore efficient.

In addition, the optical fiber and optical waveguide coupler according to an embodiment of the present disclosure may increase the efficiency of the optical elements and reduce the manufacturing cost by applying the photonic integrated circuit including the optical fiber and optical waveguide coupler achieving the high optical coupling efficiency and the broad wavelength bandwidth to the various optical elements such as the optical switches, the optical amplifiers, and the optical modulators.

In addition, the optical fiber and optical waveguide coupler according to an embodiment of the present disclosure has the large tolerance for the position and angle of the optical fiber, may thus be applicable to the coupling between not only the individual optical fiber but also to the optical fiber array including the plurality of optical fibers and the plurality of optical waveguides, and is therefore appropriate for the channel multiplexing and the mass production.

### DESCRIPTION OF THE DRAWINGS

FIG. 1 is a schematic perspective view of an optical fiber and optical waveguide coupler according to an embodiment of the present disclosure and a photonic integrated circuit including the same.

FIG. 2 is a cross-sectional view of FIG. 1.

FIG. 3 is a specific cross-sectional view of an optical fiber coupling part in FIG. 1.

FIG. 4 is a graph showing optical coupling efficiency based on a wavelength of the optical fiber and optical waveguide coupler according to an embodiment of the present disclosure.

FIG. 5 is a graph showing optical coupling efficiency based on the width Wi of one end and taper angle θt of the waveguide pattern of the optical fiber and optical waveguide coupler according to an embodiment of the present disclosure.

FIGS. 6A to 6C are graphs each showing optical coupling efficiency based on a tolerance for a position of the optical fiber in the optical fiber and optical waveguide coupler according to an embodiment of the present disclosure.

FIG. 7 is a graph showing optical coupling efficiency based on an inclination angle of a slanted cross-section of the optical fiber coupling part in FIG. 1.

FIG. 8 is a cross-sectional view of an optical fiber and optical waveguide coupler according to another embodiment of the present disclosure.

FIG. 9 is a specific cross-sectional view of the optical fiber coupling part in FIG. 8.

FIG. 10 is a cross-sectional view of an optical fiber and optical waveguide coupler according to yet another embodiment of the present disclosure.

FIG. 11 is a specific cross-sectional view of the optical fiber coupling part in FIG. 10.

FIG. 12 is a perspective view of a photonic integrated circuit according to another embodiment of the present disclosure.

### MODE FOR INVENTION

Hereinafter, embodiments of the present disclosure are described in detail with reference to the accompanying drawings so that those skilled in the art to which the present disclosure pertains may easily practice the present disclosure. The present disclosure may be modified in various different forms, and is not limited to the embodiments provided in the specification.

Portions unrelated to the description are omitted to clearly describe the present disclosure, and similar portions are denoted by similar reference numerals throughout the specification.

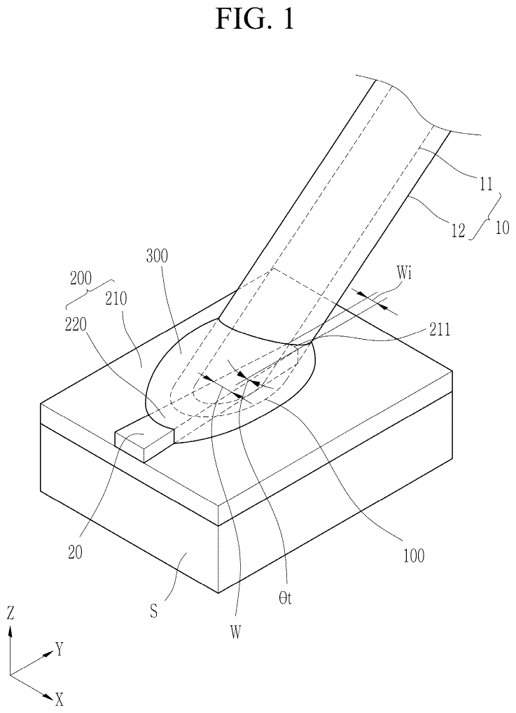

Hereinafter, an optical fiber and optical waveguide coupler according to an embodiment of the present disclosure is described in detail with reference to FIGS. 1 to 3.

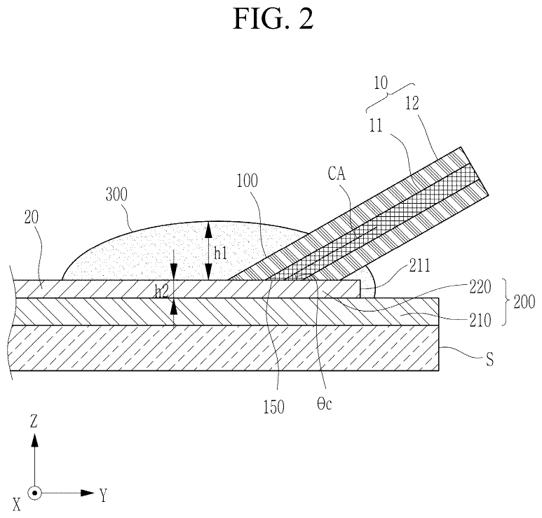

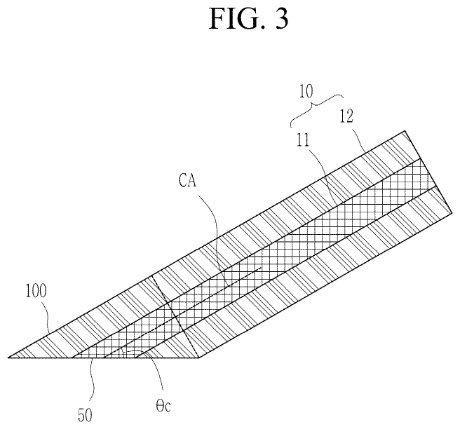

FIG. 1 is a schematic perspective view of an optical fiber and optical waveguide coupler according to an embodiment of the present disclosure and a photonic integrated circuit including the same; FIG. 2 is a cross-sectional view of FIG. 1; and FIG. 3 is a specific cross-sectional view of an optical fiber coupling part in FIG. 1.

As shown in FIGS. 1 to 3, an optical fiber and optical waveguide coupler 30 according to an embodiment of the present disclosure may include an optical fiber coupling part 100, an optical waveguide coupling part 200, and a refractive index matching part 300.

The optical fiber coupling part 100 may be disposed at one end of an optical fiber 10. The optical fiber 10 may include a core 11 and a cladding 12 surrounding and protecting the core 11. The optical fiber 10 may cause total reflection due to a refractive index difference between the core 11 and the cladding 12, and transmit light to a long distance while minimizing loss. For example, the optical fiber 10 may include the core 11 having a diameter of 9 μm and the cladding 12 having a diameter of 125 μm.

The optical fiber coupling part 100 may have an inclined slanted cross-section 50. The optical fiber coupling part 100 may expose the core 11 of the optical fiber 10 through the slanted cross-section 50.

As shown in FIGS. 2 and 3, an inclination angle θc of the slanted cross-section 50 with respect to a central axis CA of the optical fiber 10 may be greater than 0 degrees and less than 20 degrees. Optical coupling efficiency between the optical fiber and the optical waveguide may be reduced when the inclination angle θc of the slanted cross-section 50 is greater than 20 degrees.

The slanted cross-section 50 may be flat. In this case, an entire area of the slanted cross-section 50 may be in contact with the optical waveguide coupling part 200. In addition, a surface roughness of the slanted cross-section 50 may be equal to or less than 100 nm.

The optical waveguide coupling part 200 may correspond to one part of an optical waveguide 20 and be in contact with the optical fiber coupling part 100. A width W of one part of the optical waveguide coupling part 200, that is, a waveguide pattern 220, may gradually change along an extension direction Y of the optical waveguide 20. The optical waveguide coupling part 200 may include a refractive layer 210 and the waveguide pattern 220.

The refractive layer 210 may be disposed on a substrate S. A refractive index of the refractive layer 210 may be lower than a refractive index of the waveguide pattern 220. The refractive layer 210 may include a low refractive index material, such as silicon dioxide (SiO₂), which is a main component of glass, quartz, or the like.

The waveguide pattern 220 may be disposed on the refractive layer 210. The waveguide pattern 220 may include a high refractive index material, such as silicon (Si). For example, a refractive index of silicon may be 3.5.

The width W of the waveguide pattern 220 may gradually decrease along the direction Y toward an optical contact part 150 between the optical waveguide coupling part 200 and the optical fiber coupling part 100. For example, when a width Wi of one end 211 of the waveguide pattern 220 is 150 nm, a taper angle θt of the waveguide pattern 220 in the extension direction Y of the waveguide pattern 220 may be 300 to 450 μrad. It is difficult to satisfy an adiabatic condition of the waveguide pattern 220 when the taper angle θt of the waveguide pattern 220 is greater than 450 μrad.

The refractive index matching part 300 may cover the optical fiber coupling part 100 and the optical waveguide coupling part 200, fix the optical fiber coupling part 100 and the optical waveguide coupling part 200 to each other, and match a refractive index between the optical fiber coupling part 100 and the optical waveguide coupling part 200. Here, matching may indicate adjusting conditions between systems to transmit energy at the maximum efficiency when transferring energy from one system to another.

The refractive index matching part 300 may surround the optical contact part 150 between the optical waveguide coupling part 200 and the optical fiber coupling part 100. That is, a height h1 of the refractive index matching part 300 may be higher than a height h2 of the waveguide pattern 220. Accordingly, when the surface roughness of the slanted cross-section 50 is equal to or less than 100 nm, the refractive index matching part 300 may seamlessly fill a space between the optical fiber coupling part 100 and the waveguide pattern 220.

A refractive index of the refractive index matching part 300 may be equal to or greater than 1 and lower than the refractive index of the optical fiber coupling part 100. The refractive index matching part 300 may include a material such as an ultraviolet (UV) glue.

In this embodiment, the refractive index matching part 300 is in a solid state, is not necessarily limited thereto, and may also be in a liquid state or a gaseous state.

As shown in FIGS. 1 and 2, the slanted cross-section 50 of the optical fiber coupling part 100 may be in contact with the waveguide pattern 220 of the optical waveguide coupling part 200, and the refractive index of the waveguide pattern 220 may be higher than the refractive index of the refractive layer 210, and accordingly, in the optical contact part 150 between the optical fiber coupling part 100 and the optical waveguide coupling part 200, an effective refractive index of the optical waveguide coupling part 200 in an optical mode may be similar to an effective refractive index of the optical fiber coupling part 100.

In this case, optical mode hybridization may occur in the optical contact part 150, and the optical mode hybridization may satisfy a single mode condition. Here, if the optical fiber 10 and the optical waveguide 20 also satisfy the single mode condition, single mode light emitted from the optical fiber 10 may be transmitted to the optical waveguide 20 as it is without conversion to another mode. In addition, the single mode light emitted from the optical waveguide 20 may be transmitted to the optical fiber 10 as it is without conversion to another mode.

In addition, as the inclination angle θc of the optical fiber coupling part 100 is minimized, and as the taper angle θt of the waveguide pattern 220 and the width Wi of one end 211 of the waveguide pattern 220 are also minimized, a change in the effective refractive index may be minimized. The change in the effective refractive index may be minimized to increase conversion efficiency, thereby improving the optical coupling efficiency.

In addition, an applicable wavelength bandwidth may be broad if the optical fiber 10 and the optical waveguide 20 satisfy the single mode condition in a broad wavelength region.

In addition, if the single mode condition is satisfied, the optical fiber and optical waveguide coupler 30 is not significantly affected either by the position and angle of the optical fiber or an error between the central axis of the core 11 and the cladding 12 of the optical fiber 10 (core-cladding concentricity, CC), and may thus have a large tolerance for the position and angle of the optical fiber, and enable greater design flexibility.

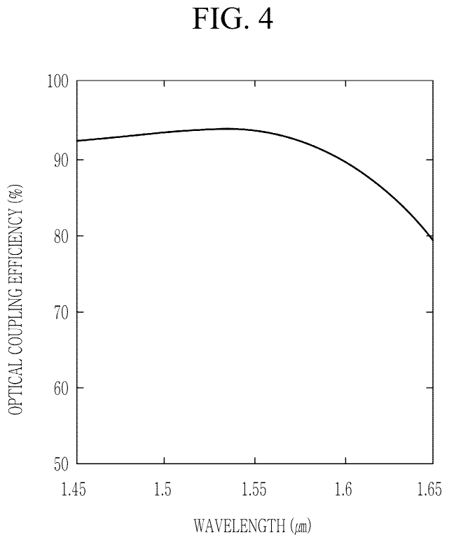

FIG. 4 is a graph showing the optical coupling efficiency based on a wavelength of the optical fiber and optical waveguide coupler according to an embodiment of the present disclosure. Here, the refractive index of the core 11 of the optical fiber 10 may be 1.48, the refractive index of the cladding 12 may be 1.44, a diameter of the core 11 may be 2.2 μm, and a radius of the cladding 12 may be 125 μm. In addition, the inclination angle θc of the slanted cross-section 50 of the optical fiber coupling part 100 may be 2 degrees, the width Wi of one end 211 of the waveguide pattern 220 may be 150 nm, the taper angle θt of the waveguide pattern 220 may be 375 μrad, the refractive layer 210 may have a thickness of 3 μm and include silicon dioxide (SiO₂), and the waveguide pattern 220 may have a thickness of 220 nm and include silicon (Si).

As shown in FIG. 4, it may be seen that the optical fiber and optical waveguide coupler 30 has optical coupling efficiency of 80% or more across an entire optical communication wavelength band of 1.45 μm to 1.65 μm. Therefore, the optical fiber and optical waveguide coupler 30 according to an embodiment of the present disclosure may be advantageous in having a broad applicable wavelength bandwidth.

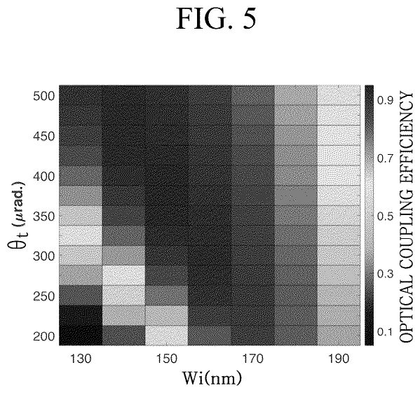

FIG. 5 is a graph showing the optical coupling efficiency based on the width Wi of one end and taper angle θt of the waveguide pattern of the optical fiber and optical waveguide coupler according to an embodiment of the present disclosure. Here, a wavelength of light may be 1550 nm.

As shown in FIG. 5, the optical fiber and optical waveguide coupler according to an embodiment of the present disclosure may be advantageous for a fabrication error because the optical coupling efficiency is appropriately maintained even when the width Wi of one end 211 and the taper angle θt of the waveguide pattern 220 are changed.

Here, the width Wi of one end 211 of the waveguide pattern 220 may be less than 190 nm, and when the width Wi of one end 211 of the waveguide pattern 220 is 150 nm, the taper angle Ot of the waveguide pattern 220 may be 300 to 450 μrad.

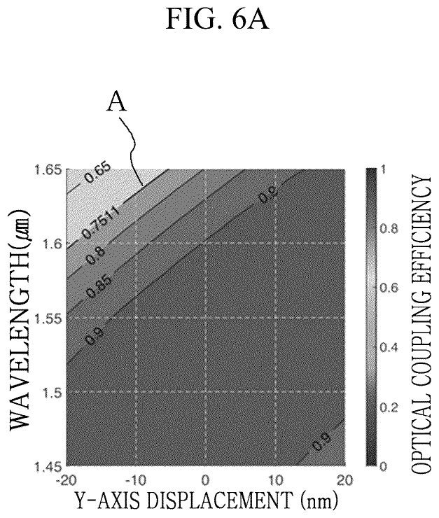

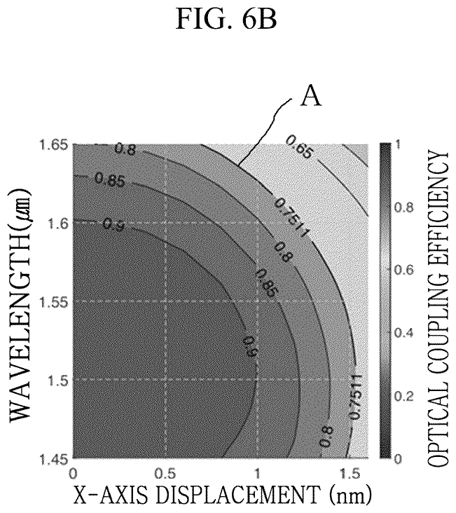

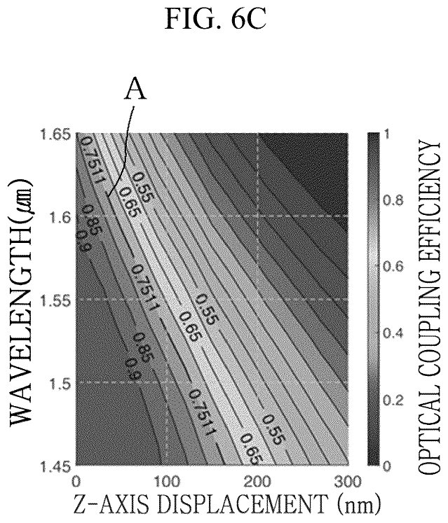

FIGS. 6A to 6C are graphs each showing the optical coupling efficiency based on the tolerance for the position of the optical fiber in the optical fiber and optical waveguide coupler according to an embodiment of the present disclosure. Here, the width Wi of one end 211 of the waveguide pattern 220 may be 150 nm and the taper angle θt of the waveguide pattern 220 may be 375 μrad. Line A marked as 0.7511 refers to a line representing a 1-dB tolerance range with respect to a maximum value of the optical coupling efficiency.

FIG. 6A is a graph showing the optical coupling efficiency based on a Y-axis displacement of the optical fiber 10 with respect to the optical waveguide 20 in the optical communication wavelength band.

In general, a central axis error between the core 11 and cladding 12 of the optical fiber 10 may be ±0.5 μm, and when this value is used as a reference, an error of about ±14.4 μm may occur in a Y-axis direction. However, as shown in FIG. 6A, it may be seen that the optical coupling efficiency has a difference of up to 5% with respect to light of a 1550 nm wavelength. That is, it may be seen that the 1-dB tolerance range (or 1-dB tolerance) in the Y-axis direction is at least greater than ±14.4 μm, and a displacement of the optical fiber in the Y-axis direction causes a negligible level of variation in the optical coupling efficiency.

FIG. 6B is a graph showing the optical coupling efficiency based on an X-axis displacement of the optical fiber with respect to the optical waveguide in the optical communication wavelength band.

As shown in FIG. 6B, the 1-dB tolerance range in an X-axis direction may be ±1.5 μm with respect to light of a 1550 nm wavelength. The central axis error between the core 11 and cladding 12 of the optical fiber 10, which is ±0.5 μm, may be within the 1-dB tolerance range, and the central axis error between the core 11 and cladding 12 of the optical fiber that occurs when the optical fiber array is applied to the plurality of optical waveguides may thus cause an acceptable level of variation in the optical coupling efficiency.

FIG. 6C is a graph showing the optical coupling efficiency based on a Z-axis displacement of the optical fiber with respect to the optical waveguide in the optical communication wavelength band.

As shown in FIG. 6C, the 1-dB tolerance range in a Z-direction may be +100 nm with respect to light of 1550 nm wavelength. Here, the surface roughness of the slanted cross-section 50 of the optical fiber coupling part 100 may be set to equal to or less than 100 nm, thereby controlling the variation in the optical coupling efficiency to an acceptable level.

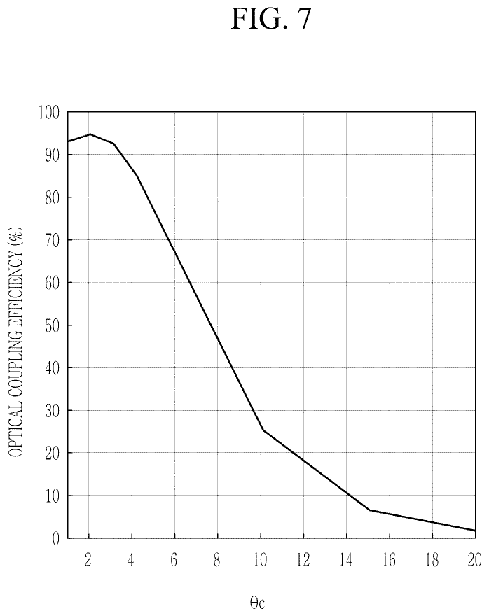

FIG. 7 is a graph showing the optical coupling efficiency based on an inclination angle of a slanted cross-section of the optical fiber coupling part in FIG. 1. Here, the width Wi of one end 211 of the waveguide pattern 220 may be 150 nm, and the taper angle Ot of the waveguide pattern 220 may be 375 μrad.

As shown in FIG. 7, it may be seen that the optical coupling efficiency is lowered to equal to or less than 5% when the inclination angle θc of the slanted cross-section 50 is greater than 20 degrees.

Meanwhile, in an embodiment above, the slanted cross-section of the optical fiber coupling part is described as being flat. However, in another embodiment, the slanted cross-section of the optical fiber coupling part may be convex while having a predetermined radius of curvature.

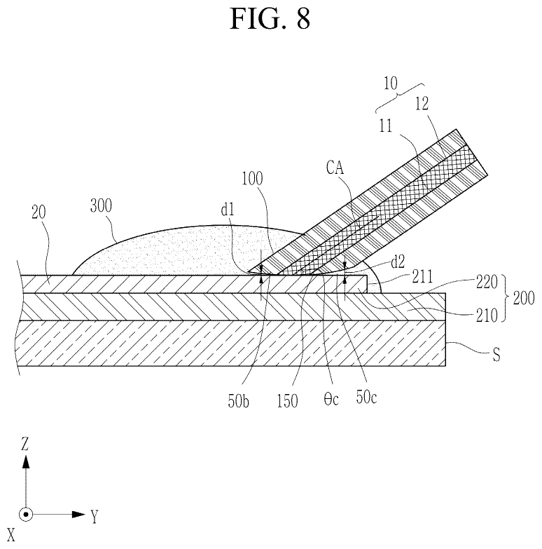

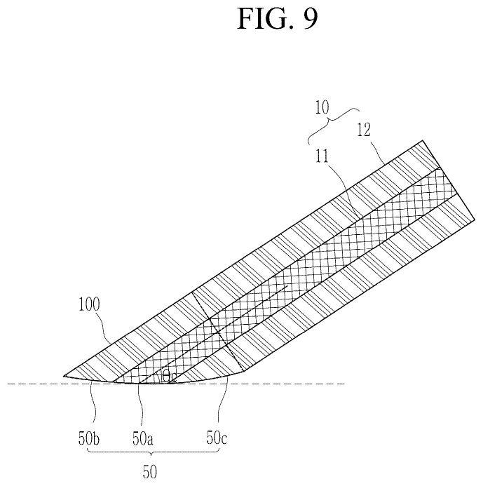

Hereinafter, an optical fiber and optical waveguide coupler according to another embodiment of the present disclosure is described in detail with reference to FIGS. 8 and 9.

FIG. 8 is a cross-sectional view of the optical fiber and optical waveguide coupler according to another embodiment of the present disclosure; and FIG. 9 is a specific cross-sectional view of the optical fiber coupling part in FIG. 8.

Another embodiment shown in FIGS. 8 and 9 is substantially the same as an embodiment shown in FIGS. 1 to 3 except for the structure of the optical fiber coupling part, and a redundant description thereof is thus omitted.

As shown in FIGS. 8 and 9, the optical fiber and optical waveguide coupler 30 according to another embodiment of the present disclosure may include the optical fiber coupling part 100, the optical waveguide coupling part 200, and the refractive index matching part 300.

The slanted cross-section 50 of the optical fiber coupling part 100 may be convex while having the predetermined radius of curvature. Accordingly, only one part 50a of the slanted cross-section 50 of the optical fiber coupling part 100 may be in contact with the waveguide pattern 220 of the optical waveguide coupling part 200, and the other parts 50b and 50c of the slanted cross-section 50 of the optical fiber coupling part 100 may be spaced apart from the waveguide pattern 220 of the optical waveguide coupling part 200 without being in contact therewith.

In this case, one part 50a of the slanted cross-section 50 of the optical fiber coupling part 100 may correspond to the optical contact part 150 between the optical waveguide coupling part 200 and the optical fiber coupling part 100. In addition, a separation spaces d1 and d2 may occur between the other parts 50b and 50c of the slanted cross-section 50 of the optical fiber coupling part 100 and a surface of the waveguide pattern 220, respectively.

Dust or small particles introduced between the optical fiber coupling part 100 and the surface of the waveguide pattern 220 may make it difficult to bring the optical fiber coupling part 100 and the waveguide pattern 220 into close contact with each other, and may cause the Z-axis displacement of the optical fiber 10, thereby reducing the optical coupling efficiency. However, the optical fiber and optical waveguide coupler 30 according to another embodiment of the present disclosure may create the separation spaces dl and d2 between the optical fiber coupling part 100 and the surface of the waveguide pattern 220 by including the slanted cross-section 50 of the optical fiber coupling part 100, which is convex and has the predetermined radius of curvature. Therefore, dust or small particles may be disposed in the separation spaces d1 and d2 between the optical fiber coupling part 100 and the surface of the waveguide pattern 220 to thus minimize the Z-axis displacement, and enable only one part 50a of the slanted cross-section 50 of the optical fiber coupling part 100 to come into close contact with the surface of the waveguide pattern 220, thereby improving the optical coupling efficiency.

Meanwhile, in the embodiment above, the slanted cross-section of the optical fiber coupling part is described to have the same inclination angle throughout. However, in another embodiment, the slanted cross-section of the optical fiber coupling part may include a plurality of sub-slanted cross-sections having different inclination angles.

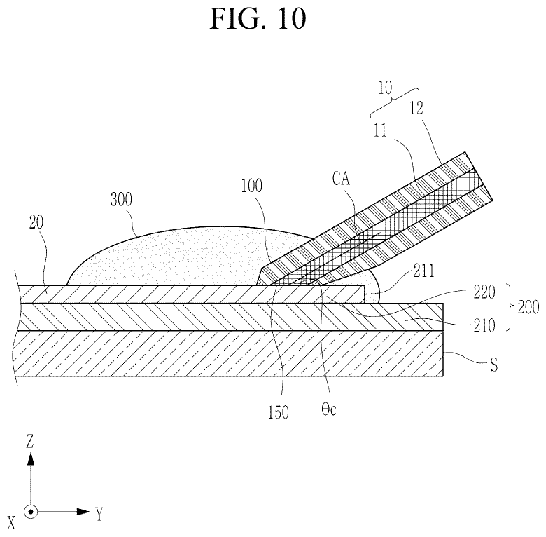

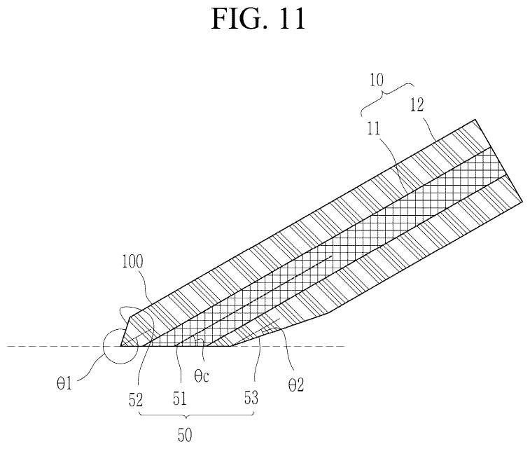

Hereinafter, an optical fiber and optical waveguide coupler according to yet another embodiment of the present disclosure is described in detail with reference to FIGS. 10 and 11.

FIG. 10 is a cross-sectional view of the optical fiber and optical waveguide coupler according to yet another embodiment of the present disclosure; and FIG. 11 is a specific cross-sectional view of the optical fiber coupling part in FIG. 10.

Yet another embodiment shown in FIGS. 10 and 11 is substantially the same as an embodiment shown in FIGS. 1 to 3 except for the structure of the optical fiber coupling part, and a redundant description thereof is thus omitted.

As shown in FIGS. 10 and 11, the optical fiber and optical waveguide coupler according to yet another embodiment of the present disclosure may include the optical fiber coupling part 100, the optical waveguide coupling part 200, and the refractive index matching part 300.

The slanted cross-section 50 of the optical fiber coupling part 100 may include a plurality of sub-slanted cross-sections 51, 52, and 53 having different inclination angles.

The plurality of sub-slanted cross-sections 51, 52, and 53 may include the contact slanted cross-section 51 in contact with the optical waveguide coupling part 200 and the non-contact slanted cross-sections 52 and 53 not in contact with the optical waveguide coupling part 200.

Inclination angles θ1 and θ2 of the non-contact slanted cross-sections 52 and 53 with respect to the central axis CA of the optical fiber 10 may be greater or smaller than the inclination angle θc of the contact slanted cross-section 51. As shown in FIG. 11, the inclination angle θ1 of the non-contact slanted cross-section 52 may be greater than the inclination angle θc of the contact slanted cross-section 51, and the inclination angle θ2 of the non-contact slanted cross-section 53 may be smaller than the inclination angle θc of the contact slanted cross-section 51.

In this way, an unnecessary part other than the contact slanted cross-section 51 may be removed from the slanted cross-section 50 of the optical fiber coupling part 100 by a method such as cutting or polishing to create the non-contact slanted cross-sections 52 and 53, thereby minimizing a contact area between the optical fiber coupling part 100 and the surface of the waveguide pattern 220.

Therefore, a probability of dust or small particles being introduced between the optical fiber coupling part 100 and the surface of the waveguide pattern 220 may be minimized, and the Z-axis displacement may also be minimized to thus enable the contact slanted cross-section 51 of the optical fiber coupling part 100 to come into close contact with the surface of the waveguide pattern 220, thereby improving the optical coupling efficiency.

Meanwhile, the photonic integrated circuit including the optical fiber and optical waveguide coupler according to an embodiment of the present disclosure is described in detail below with reference to FIG. 1.

As shown in FIG. 1, the photonic integrated circuit including the optical fiber and optical waveguide coupler according to an embodiment of the present disclosure may include the substrate S, the optical waveguide 20 disposed on the substrate S, the optical fiber 10 connected to the optical waveguide 20, and the optical fiber and optical waveguide coupler 30 coupling the optical fiber 10 to the optical waveguide 20.

The substrate S may include various materials such as silicon (Si) and silicon nitride (Si₃N₄).

The optical fiber and optical waveguide coupler 30 is not affected by the refractive index of the substrate itself, may thus be applied not only to the photonic integrated circuit including the substrate of silicon (Si) but also to the photonic integrated circuit including the substrate made of various materials, and is therefore efficient.

In addition, the photonic integrated circuit including the optical fiber and optical waveguide coupler achieving the high optical coupling efficiency and the broad wavelength bandwidth may be applied to the various optical elements such as the optical switches, the optical amplifiers, and the optical modulators, thereby increasing the efficiency of the optical elements and reducing the manufacturing cost.

Meanwhile, in the embodiment above, one optical fiber and one optical waveguide are described as being coupled to each other by using one optical fiber and optical waveguide coupler. However, in another embodiment, the optical fiber array including the plurality of optical fibers may be coupled to the plurality of optical waveguides by using the plurality of optical fiber and optical waveguide couplers.

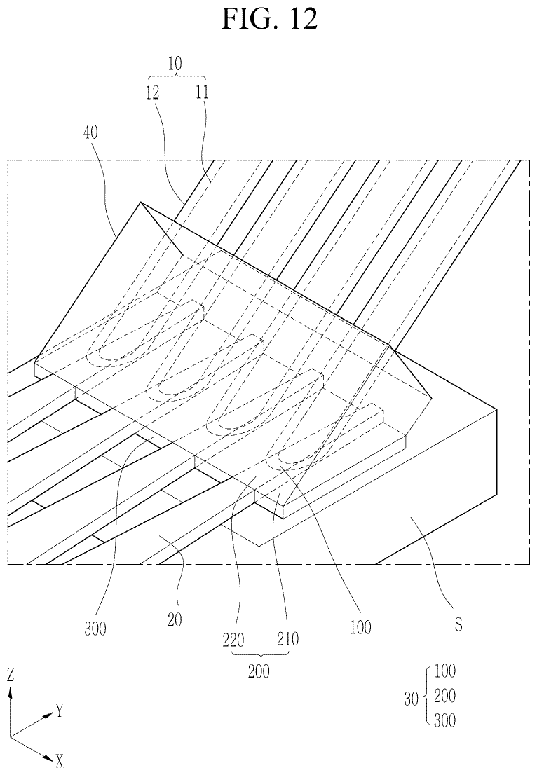

Hereinafter, a photonic integrated circuit according to another embodiment of the present disclosure is described in detail with reference to FIG. 12.

FIG. 12 is a perspective view of the photonic integrated circuit according to another embodiment of the present disclosure.

Another embodiment shown in FIG. 12 is substantially the same as an embodiment shown in FIGS. 1 to 3 except for the structure for coupling the optical fiber array to the plurality of optical waveguides, and a redundant description thereof is thus omitted.

As shown in FIG. 12, the photonic integrated circuit according to another embodiment of the present disclosure may include the substrate S, the optical fiber array including the plurality of optical fibers 10, the plurality of optical waveguides 20, the plurality of optical fiber and optical waveguide couplers 30, and an optical fiber fixing part 40.

The plurality of optical fibers 10 may be aligned to be parallel to each other. The plurality of optical waveguides 20 may be connected to the plurality of optical fibers 10, respectively. The plurality of optical fiber and optical waveguide couplers 30 may couple the plurality of optical fibers 10 to the plurality of optical waveguides 20, respectively.

The optical fiber and optical waveguide coupler 30 may include the optical fiber coupling part 100, the optical waveguide coupling part 200, and the refractive index matching part 300.

The optical fiber fixing part 40 may be disposed on the refractive index matching part 300, and cover and fix parts of an optical fiber array 10 and the plurality of optical waveguides 20 together.

As shown in FIG. 6, the optical fiber and optical waveguide coupler 30 has a large tolerance for the position and angle of the optical fiber, may thus be applicable to the coupling not only between the individual optical fiber and the individual optical waveguide but also between the optical fiber array and the plurality of optical waveguides, and is therefore suitable for channel multiplexing and mass production.

That is, the optical fiber and optical waveguide coupler 30 has a large tolerance for the position and angle of the optical fiber to thus minimize a difference in the optical coupling efficiency caused by the random central axis errors between the core 11 and cladding 12 of each optical fiber 10 and facilitate alignment, when applying the optical fiber array, thereby enabling the use of a uniform structure design, which is advantageous for the channel multiplexing.

In addition, the photonic integrated circuit according to another embodiment of the present disclosure may couple the optical fiber array 10 to the plurality of optical waveguides 20 in a simplified manner by including the optical fiber array 10, the plurality of optical waveguides 20, the optical fiber and optical waveguide coupler 30, and the optical fiber fixing part 40. Accordingly, no separate complex device is required to install the optical fiber and optical waveguide coupler, thereby providing an economical configuration suitable for the mass production.

Although the embodiments of the present disclosure have been described in detail hereinabove, the present disclosure is not limited thereto. It is apparent to those skilled in the art to which the present disclosure pertains that the present disclosure may be variously modified and altered without departing from the spirit and scope of the present disclosure claimed in the claims described below.

1. An optical fiber and optical waveguide coupler comprising:
an optical fiber coupling part disposed at one end of an optical fiber and having an inclined slanted cross-section;
an optical waveguide coupling part corresponding to one part of an optical waveguide and in contact with the optical fiber coupling part; and
a refractive index matching part covering the optical fiber coupling part and the optical waveguide coupling part and matching a refractive index between the optical fiber coupling part and the optical waveguide,
wherein the optical fiber coupling part exposes a core of the optical fiber, and
a width of the one part of the optical waveguide coupling part gradually changes along an extension direction of the optical waveguide.

2. The coupler of claim 1, wherein
an inclination angle of the slanted cross-section with respect to a central axis of the optical fiber is greater than 0 degrees and less than 20 degrees.

3. The coupler of claim 2, wherein
the slanted cross-section is flat, and an entire area of the slanted cross-section is in contact with the optical waveguide coupling part.

4. The coupler of claim 2, wherein
the slanted cross-section has a predetermined radius of curvature, is convex, and only one part of the slanted cross-section is in contact with the optical waveguide coupling part.

5. The coupler of claim 2, wherein
the slanted cross-section includes a plurality of sub-slanted cross-sections having different inclination angles, and
the plurality of sub-slanted cross-sections include
a contact slanted cross-section in contact with the optical waveguide coupling part and
a non-contact slanted cross-section not in contact with the optical waveguide coupling part.

6. The coupler of claim 2, wherein
a surface roughness of the slanted cross-section is equal to or less than 100 nm.

7. The coupler of claim 2, wherein
the optical waveguide coupling part includes
a refractive layer disposed on a substrate and
a waveguide pattern disposed on the refractive layer, and
a refractive index of the waveguide pattern is greater than a refractive index of the refractive layer.

8. The coupler of claim 7, wherein
a width of the waveguide pattern gradually decreases along a direction toward an optical contact part between the optical waveguide coupling part and the optical fiber coupling part.

9. The coupler of claim 8, wherein
when a width of one end of the waveguide pattern is 150 nm,
a taper angle of the waveguide pattern in its extension direction is 300 to 450 μrad.

10. The coupler of claim 9, wherein
the refractive index matching part surrounds the optical contact part.

11. The coupler of claim 10, wherein
a refractive index of the refractive index matching part is equal to or greater than 1 and is lower than a refractive index of the optical fiber coupling part.

12. A photonic integrated circuit comprising:
a substrate;
an optical waveguide disposed on the substrate;
an optical fiber connected to the optical waveguide; and
an optical fiber and optical waveguide coupler coupling the optical fiber to the optical waveguide,
wherein the optical fiber and optical waveguide coupler includes
an optical fiber coupling part disposed at an end of the optical fiber and having an inclined slanted cross-section,
an optical waveguide coupling part corresponding to one part of the optical waveguide and in contact with the optical fiber coupling part, and
a refractive index matching part covering the optical fiber coupling part and the optical waveguide coupling part and matching a refractive index between the optical fiber coupling part and the optical waveguide,
the optical fiber coupling part exposes a core of the optical fiber, and
a width of the one part of the optical waveguide coupling part gradually decreases along an extension direction of the optical waveguide.

13. A photonic integrated circuit comprising:
a substrate;
a plurality of optical waveguides disposed on the substrate;
an optical fiber array including a plurality of optical fibers connected to the plurality of optical waveguides, respectively;
a plurality of optical fiber and optical waveguide couplers coupling the optical fiber array to the plurality of optical waveguides; and
an optical fiber fixing part fixing the optical fiber array onto the plurality of optical waveguides,
wherein the optical fiber and optical waveguide coupler includes
